(19) United States
(12) Patent Application Publication
(10) Pub. No.: US 2024/0364410 A1
(43) Pub. Date: Oct. 31, 2024

(54) MULTI-PUSCH REPETITIONS WITH JOINT CHANNEL ESTIMATION

(71) Applicant: QUALCOMM Incorporated, San Diego, CA (US)

(72) Inventors: Shaozhen GUO, Beijing (CN); Mostafa KHOSHNEVISAN, San Diego, CA (US); Xiaoxia ZHANG, San Diego, CA (US)

(21) Appl. No.: 18/566,064

(22) PCT Filed: Aug. 27, 2021
(86) PCT No.: PCT/CN2021/114987

§ 371 Date: Nov. 30, 2023

(51) Int. Cl. H04B 7/12; H04B 7/06; H04L 5/00; H04L 25/02; H04W 72/232

(52) U.S. Cl. CPC H04B 7/12; H04B 7/06952; H04L 5/0012; H04L 25/0204; H04W 72/232

(57) ABSTRACT

Apparatus and method for multi-PUSCH repetitions with joint channel estimation The apparatus receives, from a base station, a joint channel estimation configuration and at least one of a frequency hopping configuration or a beam mapping configuration. The apparatus receives DCI scheduling a plurality of PUSCHs having multiple repetitions. The apparatus applies a frequency hopping configuration or a beam mapping configuration based on the joint channel estimation configuration and at least one of a received frequency hopping configuration or a received beam mapping configuration. The apparatus communicates, with the base station, based on the received frequency hopping configuration or the received beam mapping configuration. The apparatus maintains phase continuity across one or more TBs scheduled by the DCI.

### TECHNICAL FIELD

The present disclosure relates generally to communication systems, and more particularly, to a configuration for multi-physical uplink shared channel (PUSCH) repetitions with joint channel estimation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus receives, from a base station, a joint channel estimation configuration and at least one of a frequency hopping configuration or a beam mapping configuration. The apparatus receives downlink control information (DCI) scheduling a plurality of physical uplink shared channels (PUSCHs) having multiple repetitions. The apparatus applies a frequency hopping configuration or a beam mapping configuration based on the joint channel estimation configuration and at least one of a received frequency hopping configuration or a received beam mapping configuration. The apparatus communicates, with the base station, based on the received frequency hopping configuration or the received beam mapping configuration. The apparatus maintains phase continuity across one or more transport blocks (TBs) scheduled by the DCI.

In an aspect of the disclosure, a method, a computer-readable medium, and an apparatus are provided. The apparatus may be a device at a base station. The device may be a processor and/or a modem at a base station or the base station itself. The apparatus transmits, to a user equipment (UE), a joint channel estimation configuration and at least one of a frequency hopping configuration or a beam mapping configuration. The apparatus transmits downlink control information (DCI) scheduling a plurality of physical uplink shared channels (PUSCHs) having multiple repetitions. The apparatus receives, from the UE, uplink transmission based on the at least one of the frequency hopping configuration or the beam mapping configuration. The apparatus performs a joint channel estimation procedure on the uplink transmission received from the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A and 4B are diagrams of joint channel estimation across transmission occasions of a same frequency hop.

FIGS. 5A and 5B are diagrams of joint channel estimation across consecutive transmission occasions.

FIGS. 6A and 6B are diagrams of joint channel estimation across consecutive X transmission occasions.

FIG. 7 is a diagram of joint channel estimation across transmission occasions of a given TB.

FIG. 8 is a diagram of joint channel estimation across consecutive transmission occasions and a beam mapping pattern.

FIGS. 9A and 9B are diagrams of joint channel estimation across X transmission occasions of a given TB.

FIG. 10 is a call flow diagram of signaling between a UE and a base station.

FIG. 11 is a flowchart of a method of wireless communication.

FIG. 12 is a diagram illustrating an example of a hardware implementation for an example apparatus.

FIG. 13 is a flowchart of a method of wireless communication.

FIG. 14 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

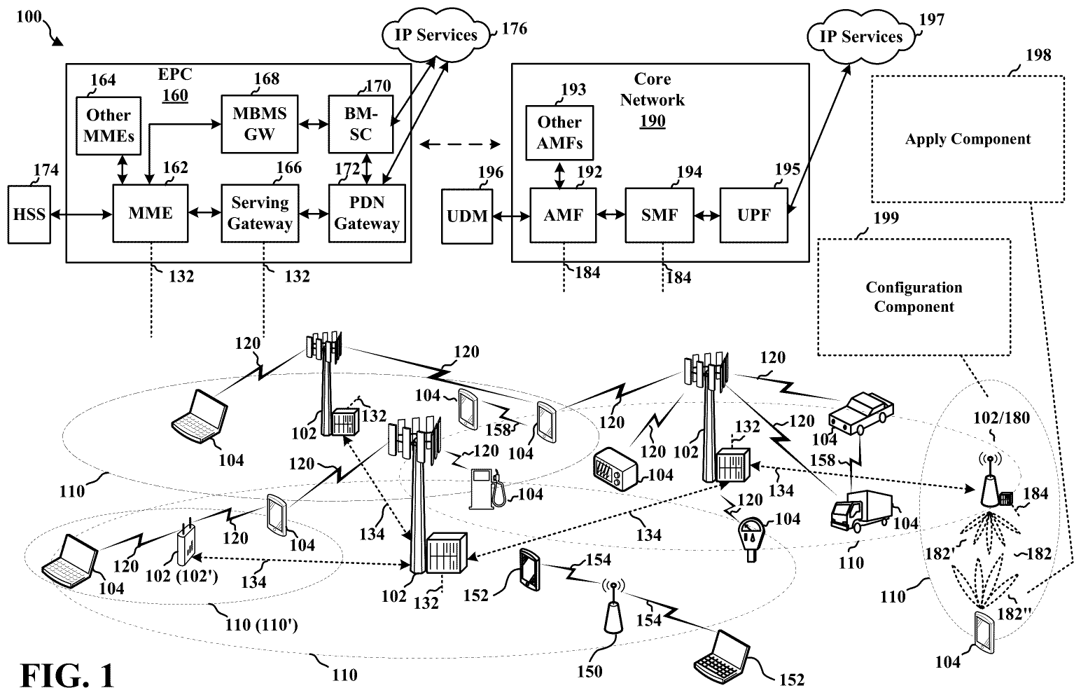

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, cNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to apply a beam mapping configuration or a frequency hopping configuration when joint channel estimation is configured. For example, the UE 104 may comprise an apply component 198 configured to apply a beam mapping configuration or a frequency hopping configuration when joint channel estimation is configured. The UE 104 may receive, from a base station 180, a joint channel estimation configuration and at least one of a frequency hopping configuration or a beam mapping configuration. The UE 104 may receive DCI scheduling a plurality of PUSCHs having multiple repetitions. The UE 104 may apply a frequency hopping configuration or a beam mapping configuration based on the joint channel estimation configuration and at least one of a received frequency hopping configuration or a received beam mapping configuration. The UE 104 may communicate, with the base station 180, based on the received frequency hopping configuration or the received beam mapping configuration. The UE 104 may maintain phase continuity across one or more TBs scheduled by the DCI.

Referring again to FIG. 1, in certain aspects, the base station 180 may be configured to configure a UE 104 to apply a beam mapping configuration or a frequency hopping configuration when joint channel estimation is configured. For example, the base station 180 may comprise a configuration component 199 configured to configure a UE 104 to apply a beam mapping configuration or a frequency hopping configuration when joint channel estimation is configured. The base station 180 may transmit, to a UE 104, a joint channel estimation configuration and at least one of a frequency hopping configuration or a beam mapping configuration. The base station 180 may transmit DCI scheduling a plurality of PUSCHs having multiple repetitions. The base station 180 may receive, from the UE 104, uplink transmission based on the at least one of the frequency hopping configuration or the beam mapping configuration. The base station 180 may perform a joint channel estimation procedure on the uplink transmission received from the UE 104.

Although the following description may be focused on 5G NR, the concepts described herein may be applicable to other similar areas, such as LTE, LTE-A, CDMA, GSM, and other wireless technologies.

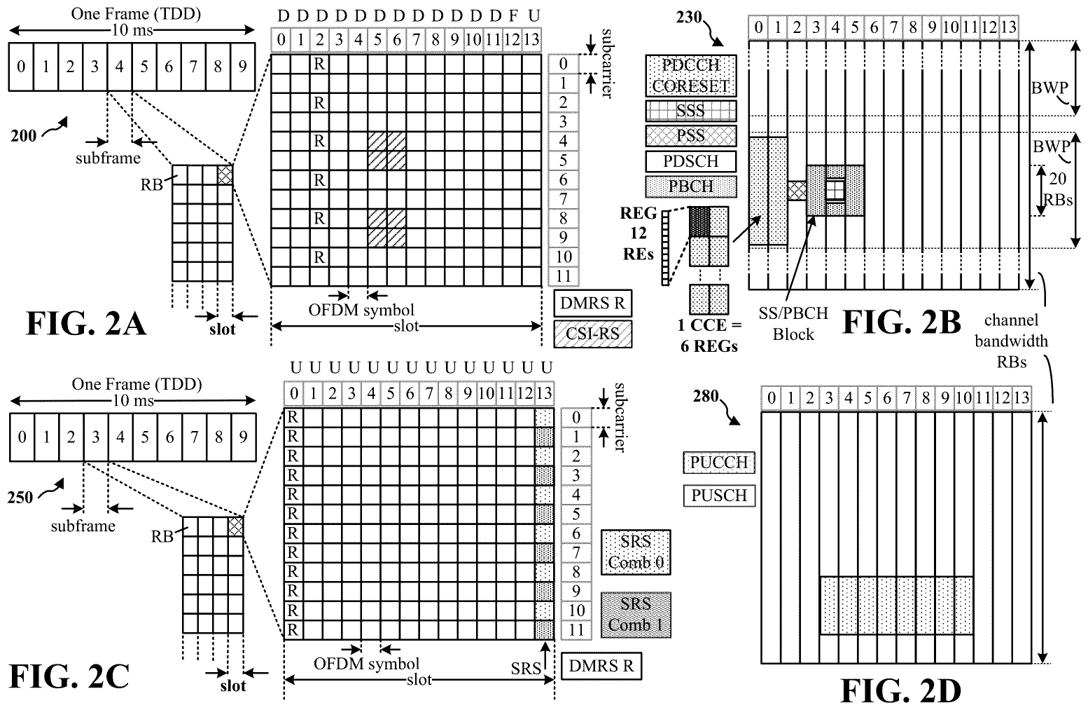

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2μ*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

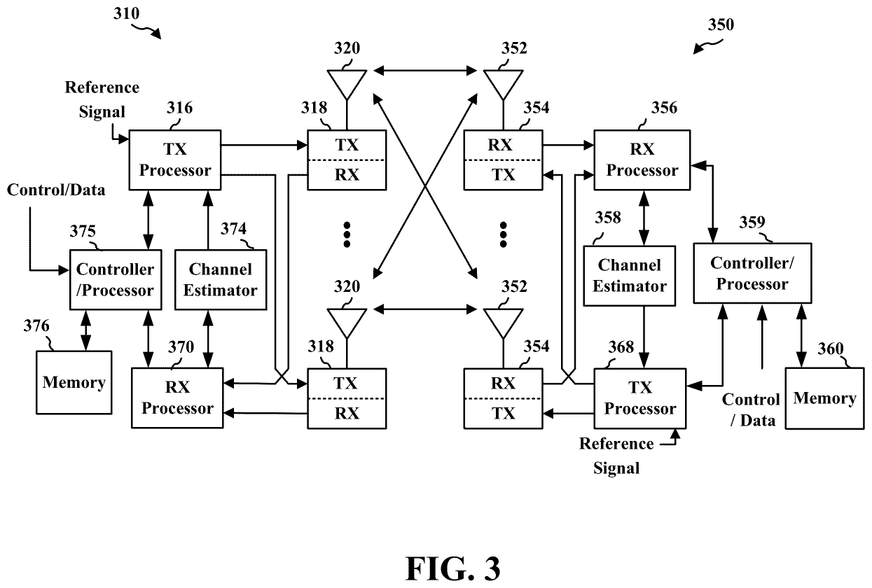

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

In wireless communication systems, joint channel estimation for PUSCH transmissions may be enabled or disabled via RRC configuration for a UE. For example, a UE may receive a joint channel estimation configuration where the UE receives an RRC configuration to enable joint channel estimation for the UE. In some instances, joint channel estimation may be disabled by a separate RRC signal, while in some instances, the joint channel estimation configuration may include instructions as to when to disable the joint channel estimation. In some instances, the enabling or disabling of the joint channel estimation for PUSCH transmissions may enable or disable DMRS bundling for PUSCH transmissions under the condition that the UE maintain power consistency and phase continuity. In order for a base station to conduct joint channel estimation, the UE may need to maintain power consistency and phase continuity which may have some impact on the frequency hopping and beam mapping. Aspects presented herein provide a configuration for frequency hopping and beam mapping when joint channel estimation is configured.

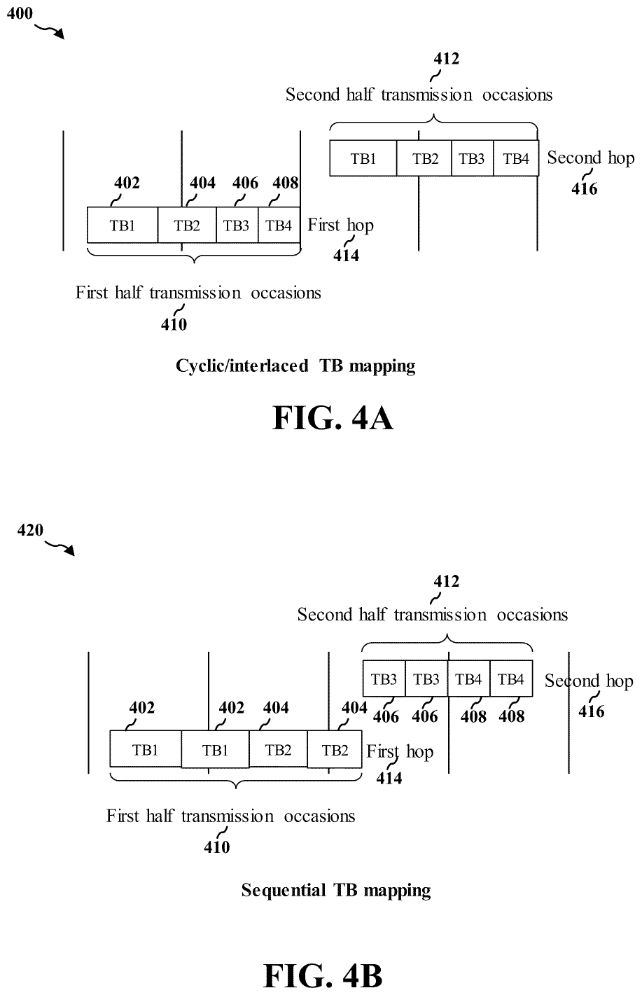

FIGS. 4A and 4B are diagrams 400, 420 of phase continuity across transmission occasions of a same frequency hop. The diagram 400 includes multiple scheduled TBs (e.g., TB1 402, TB2 404, TB3 406, TB4 408) with cyclic or interlaced TB mapping, while diagram 420 includes multiple scheduled TBs (e.g., TB1 402, TB2 404, TB3 406, TB4 408) with sequential TB mapping. When joint channel estimation is configured, and a DCI schedules multi-PUSCHs, each with multiple repetitions, the UE may maintain phase continuity across TBs (e.g., 402, 404, 406, 408) as well as across repetitions of the same TB that are scheduled by the single DCI. The UE may maintain phase continuity for joint channel estimation at the base station across transmission occasions of all TBs scheduled by one DCI that belong to the same frequency hop. For example, to enable joint channel estimation across consecutive transmission occasions, a first half of transmission occasions 410 across all repetitions of all TBs (e.g., 402, 404, 406, 408) may be allocated to a first frequency hop 414. A second half of transmission occasions 412 across all repetitions of all TBs (e.g., 402, 404, 406, 408) may be allocated to a second frequency hop 416. To ensure frequency diversity for the same TB, cyclic or interlaced TB mapping may be utilized, as shown in FIG. 4A. In instances where joint channel estimation across different TBs is configured and frequency hopping is enabled, cyclic/interlaced TB mapping may be applied. In instances where joint channel estimation across different TBs is configured and cyclic/interlaced TB mapping is configured, frequency hopping across a first half of transmission occasions and a second half of transmission occasions across all repetitions of all TBs may be applied. In some instances, frequency hopping across a first half of transmission occasions and a second half of transmission occasions across all repetitions of all TBs may be configured as an additional option for frequency hopping.

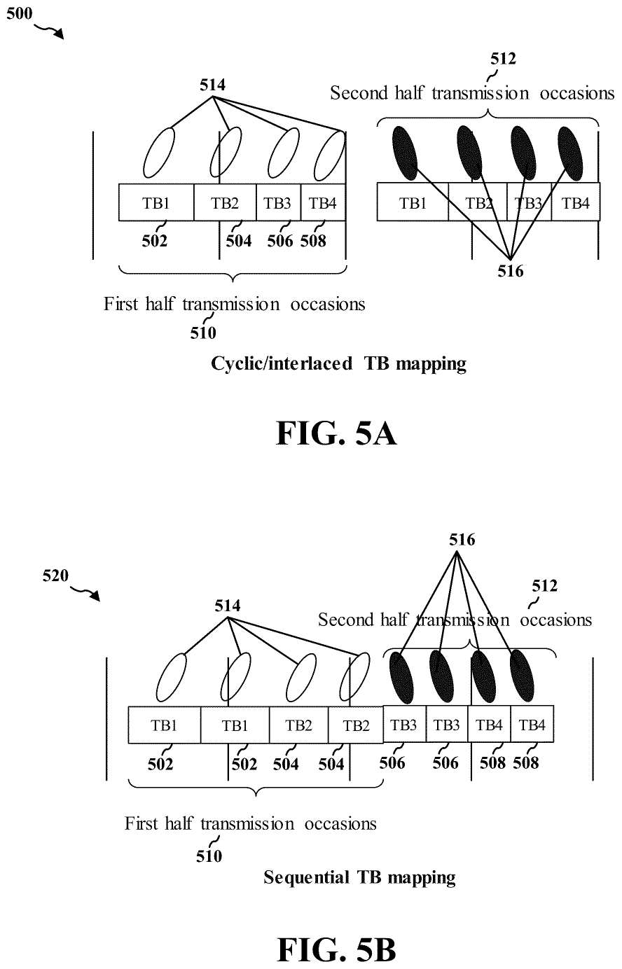

FIGS. 5A and 5B are diagrams 500, 520 of phase continuity across transmission occasions of all TBs scheduled by one DCI that are associated with the same beam. The diagram 500 includes multiple scheduled TBs (e.g., TB1 502, TB2 504, TB3 506, TB4 508) with cyclic or interlaced TB mapping, while diagram 520 includes multiple scheduled TBs (e.g., TB1 502, TB2 504, TB3 506, TB4 508) with sequential TB mapping. When joint channel estimation is configured, and a DCI schedules multi-PUSCHs, each with multiple repetitions, the UE may maintain phase continuity across transmission occasions of all TBs (e.g., TB1 502, TB2 504, TB3 506, TB4 508) scheduled by one DCI that are associated with the same beam. To enable joint channel estimation across consecutive transmission occasions, a first half of transmission occasions 510 across all repetitions of all TBs are associated with a first beam 514, and a second half of transmission occasions 512 across all repetitions of all TBs are associated to a second beam 516. Cyclic or interlaced TB mapping may be utilized to ensure spatial diversity for the same TB. For example, cyclic/interlaced TB mapping may be applied when joint channel estimation across different TBs is configured and multi-TRP is enabled. In instances where joint channel estimation across different TBs is configured and cyclic/interlaced TB mapping is configured, beam mapping at a first half of transmission occasions using a first beam and beam mapping at a second half of transmission occasions using a second beam across all repetitions of all TBs may be applied. In some instances, beam mapping across a first half of transmission occasions using a first beam and beam mapping at a second half of transmission occasions using a second beam across all repetitions of all TBs may be configured as an additional option for beam mapping.

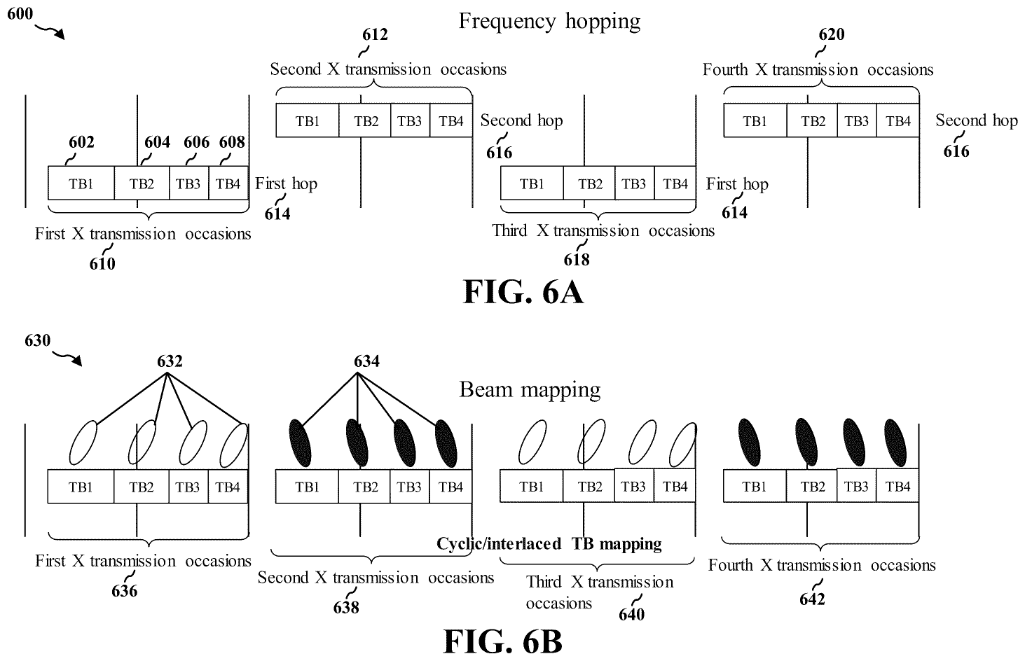

FIGS. 6A and 6B are diagrams 600, 630 of phase continuity across X transmission occasions of all TBs scheduled by one DCI. A value for X may be configured via RRC signaling. The diagram 600 includes multiple scheduled TBs (e.g., TB1 602, TB2 604, TB3 606, TB4 608) with cyclic or interlaced TB mapping and frequency hopping, while the diagram 630 includes multiple scheduled TBs (e.g., TB1 602, TB2 604, TB3 606, TB4 608) with cyclic or interlaced TB mapping and beam mapping. In instances of frequency hopping, to enable joint channel estimation across consecutive X transmission occasions, a first X transmission occasions 610 may be allocated to a first frequency hop 614, a second X transmission occasions 612 may be allocated to a second frequency hop 616, a third X transmission occasions 618 may be allocated to the first frequency hop 614, and a fourth X transmission occasions 620 may be allocated to the second frequency hop 616. This pattern may repeat based on the value of X. In instances of beam mapping, to enable joint channel estimation across consecutive X transmission occasions, a first X transmission occasions 636 may be allocated to a first beam 632, a second X transmission occasions 638 may be allocated to a second beam 634, a third X transmission occasions 640 may be allocated to the first beam 632, a fourth X transmission occasions 642 may be allocated to the second beam 634. For joint channel estimation, the X transmission occasions may be consecutive or non-consecutive. In instances where the X transmission occasions are non-consecutive, a phase tracking reference signal (PT-RS) may be used to estimate the phase offset and provide some phase compensation based on the estimated phase offset.

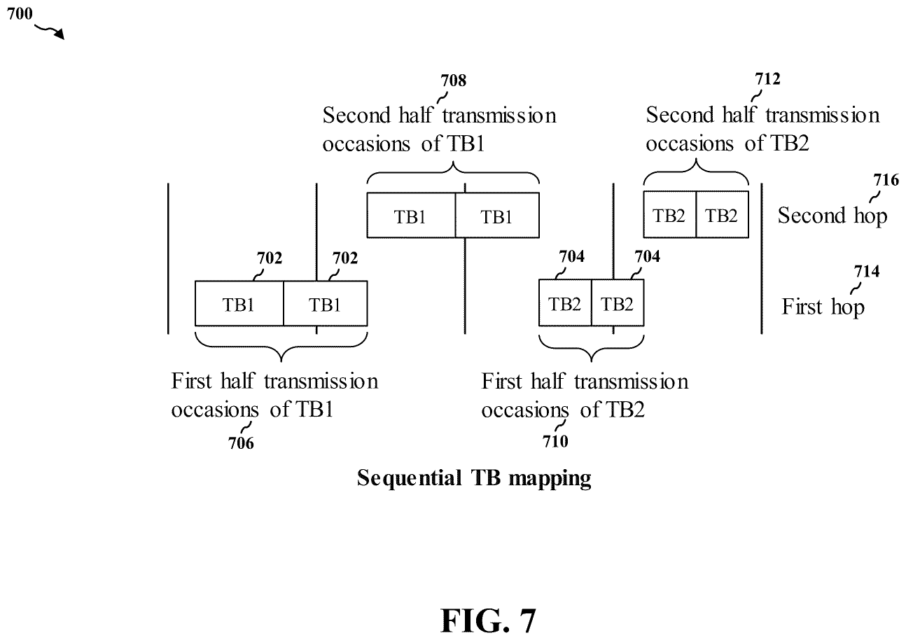

FIG. 7 is a diagram 700 of phase continuity across repetitions of the same TB. The diagram 700 includes multiple TBs (e.g., TB1 702, TB2 704) with multiple repetitions scheduled by a DCI. The UE may maintain phase continuity, for joint channel estimation at a base station, across transmission occasions of a give TB (e.g., 702, 704) scheduled by one DCI that belongs to the same frequency hop (e.g., first frequency hop 714, second frequency hop 716). In one example, to enable joint channel estimation across consecutive transmission occasions, a first half of transmission occasions 706 across all repetitions of a first TB (e.g., TB1 702) may be allocated to a first frequency hop 714, and a second half of transmission occasions 708 across all repetitions of the first TB (e.g., TB1 702) may be allocated to a second frequency hop 716. In another example, to enable joint channel estimation across consecutive transmission occasions, a first half of transmission occasions 710 across all repetitions of a second TB (e.g., TB2 704) may be allocated to a first frequency hop 714, and a second half of transmission occasions 712 across all repetitions of the second TB (e.g., TB2 704) may be allocated to a second frequency hop 716. Sequential TB mapping may be utilized to enable joint channel estimation across consecutive transmission occasions of the same TB. In some aspects, sequential TB mapping may be applied when joint channel estimation across the same TBs is configured and frequency hopping is enabled. In instances where joint channel estimation across the same TB is configured and sequential TB mapping is configured, frequency hopping across a first half of repetitions of a given TB and a second half of repetitions of the given TB may be applied. In some instances, frequency hopping across a first half of repetitions of a given TB and a second half of repetitions of the given TB may be configured as an additional option for frequency hopping.

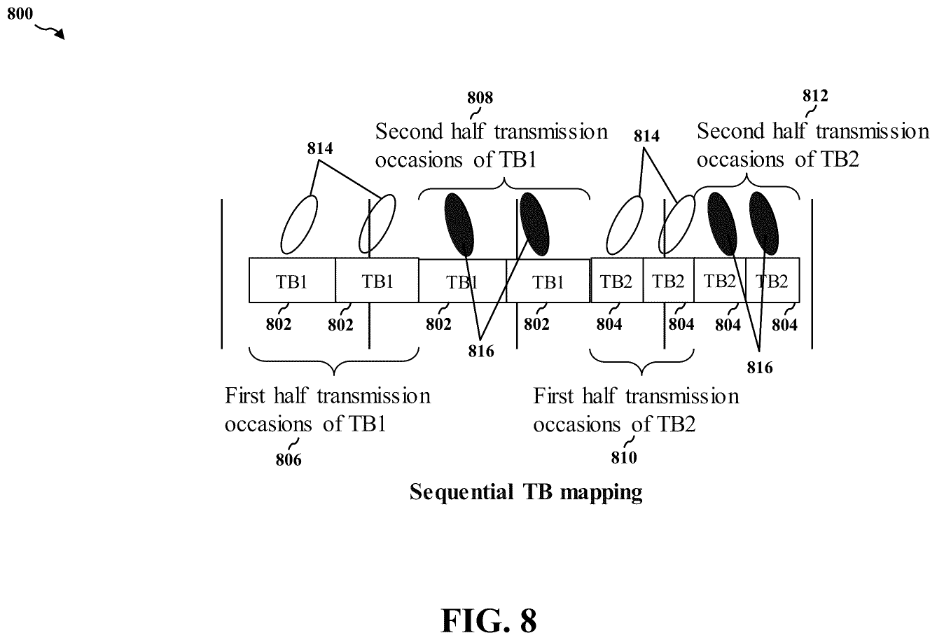

FIG. 8 is a diagram 800 of phase continuity across transmission occasions of a given TB scheduled by a DCI that are associated with a same beam. The diagram 800 includes multiple scheduled TBs (e.g., TB1 802, TB2 804) with sequential TB mapping. To enable joint channel estimation across consecutive transmission occasions, a first half of transmission occasions across all repetitions of a given TB may be associated to a first beam, and a second half of transmission occasions across all repetitions of the given TB may be associated to a second beam. For example, a first half of transmission occasions 806 across all repetitions of a first TB (e.g., TB1 802) may be associated to a first beam 814, a second half of transmission occasions 808 across all repetitions of the first TB (e.g., TB1 802) may be associated to a second beam 816. In another example, a first half of transmission occasions 810 across all repetitions of a second TB (e.g., TB2 804) may be associated to a first beam 814, and a second half of transmission occasions 812 across all repetitions of the second TB (e.g., TB2 804) may be associated to a second beam 816. In some instances, sequential TB mapping may be utilized to enable joint channel estimation across consecutive transmission occasions of the same TB. In some instances, beam mapping across a first half of transmission occasions of all repetitions of a given TB and a second half of transmission occasions of all repetitions of the given TB may be applied when joint channel estimation across the same given TB is configured and sequential TB mapping is configured. In some instances, beam mapping across a first half of transmission occasions of all repetitions of a given TB and a second half of transmission occasions of all repetitions of the given TB may be configured as an additional option for beam mapping.

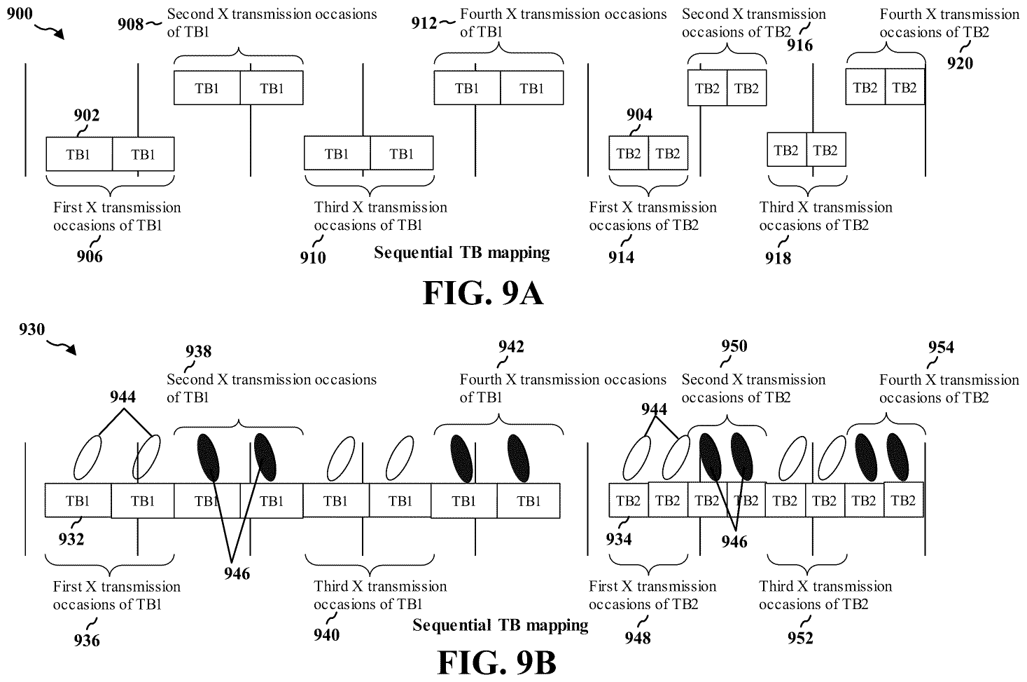

FIGS. 9A and 9B are diagrams 900, 930 of phase continuity across X transmission occasions of a given TB scheduled by a DCI. A value of X may be configured via RRC signaling. The diagram 900 includes multiple scheduled TBs (e.g., TB1 902, TB2 904) with sequential TB mapping and frequency hopping, while the diagram 930 includes multiple scheduled TBs (e.g., TB1 932, TB2 934) with sequential TB mapping and beam mapping. To enable joint channel estimation across consecutive transmission occasions, for frequency hopping, a first X transmission occasions 906 across all repetitions of a given TB (e.g., TB1 902) may be allocated to a first frequency hop, a second X transmission occasions 908 across all repetitions of the given TB (e.g., TB1 902) may be allocated to a second frequency hop, a third X transmission occasions 910 across all repetition of the given TB (e.g., TB1 902) may be allocated to the first frequency hop, a fourth X transmission occasions 912 across all repetitions of the given TB (e.g., TB1 902) may be allocated to the second frequency hop. In another example, a first X transmission occasions 914 across all repetitions of a given TB (e.g., TB2 904) may be allocated to a first frequency hop, a second X transmission occasions 916 across all repetitions of the given TB (e.g., TB2 904) may be allocated to a second frequency hop, a third X transmission occasions 918 across all repetition of the given TB (e.g., TB2 904) may be allocated to the first frequency hop, a fourth X transmission occasions 920 across all repetitions of the given TB (e.g., TB2 904) may be allocated to the second frequency hop. For beam mapping, a first X transmission occasions 936 across all repetitions of a given TB (e.g., TB1 932) may be allocated to the first beam 944, a second X transmission occasions 938 across all repetitions of the given TB (e.g., TB1 932) may be allocated to the second beam 946, a third X transmission occasions 940 across all repetition of the given TB (e.g., TB1 932) may be allocated to the first beam 944, a fourth X transmission occasions 942 across all repetitions of the given TB (e.g., TB1 932) may be allocated to the second beam 946. In another example, a first X transmission occasions 948 across all repetitions of a given TB (e.g., TB2 934) may be allocated to the first beam 944, a second X transmission occasions 950 across all repetitions of the given TB (e.g., TB2 934) may be allocated to the second beam 946, a third X transmission occasions 952 across all repetition of the given TB (e.g., TB2 934) may be allocated to the first beam 944, a fourth X transmission occasions 954 across all repetitions of the given TB (e.g., TB2 934) may be allocated to the second beam 946. For joint channel estimation at the base station, X transmission occasions may be consecutive or non-consecutive. In instances where the X transmission occasions are non-consecutive, PT-RS may be used to estimate the phase offset and the base station may provide some phase compensation based on the estimated phase offset.

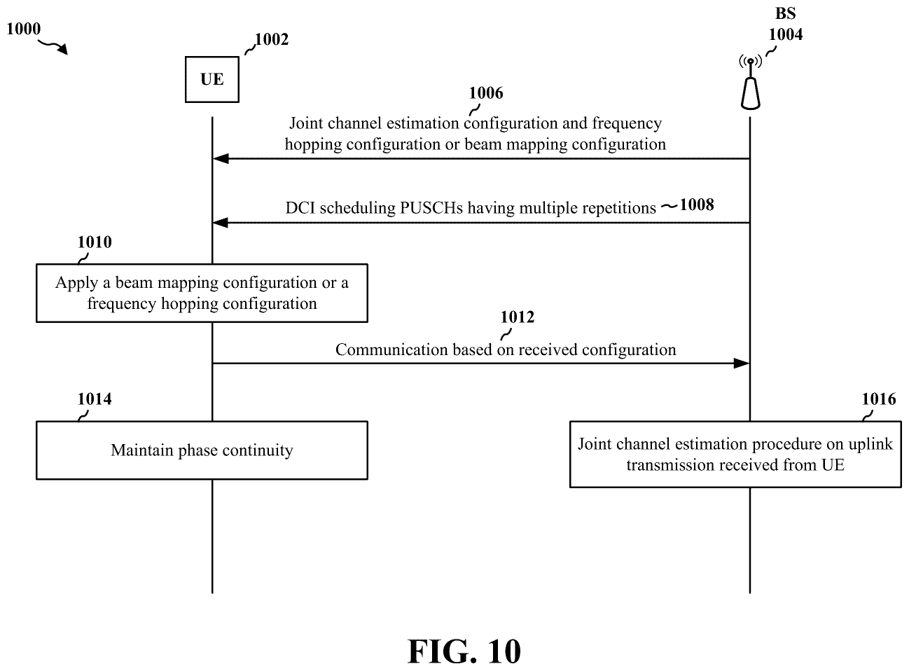

FIG. 10 is a call flow diagram 1000 of signaling between a UE 1002 and a base station 1004. The base station 1004 may be configured to provide at least one cell. The UE 1002 may be configured to communicate with the base station 1004. For example, in the context of FIG. 1, the base station 1004 may correspond to base station 102/180 and, accordingly, the cell may include a geographic coverage area 110 in which communication coverage is provided and/or small cell 102′ having a coverage area 110′. Further, a UE 1002 may correspond to at least UE 104. In another example, in the context of FIG. 3, the base station 1004 may correspond to base station 310 and the UE 1002 may correspond to UE 350.

At 1006, the base station 1004 may transmit the joint channel estimation configuration and at least one of a frequency hopping configuration or a beam mapping configuration. The base station may transmit the joint channel estimation configuration and at least one of the frequency hopping configuration or the beam mapping configuration to the UE 1002. The UE 1002 may receive the joint channel estimation configuration and at least one of the frequency hopping configuration or the beam mapping configuration from the base station 1004.

At 1008, the base station 1004 may transmit DCI scheduling a plurality of PUSCHs. The base station may transmit DCI scheduling a plurality of PUSCHs having multiple repetitions. The base station may transmit the DCI to the UE 1002. The UE 1002 may receive the DCI scheduling a plurality of PUSCHs having multiple repetitions from the base station 1004. In some aspects, the joint channel estimation procedure may be performed over each of one or more transmission occasions of the PUSCHs. In some aspects, the one or more transmission occasions may be consecutive or non-consecutive. In such aspects, a phase tracking reference signal (PT-RS) may be used to estimate a phase offset.

At 1010, the UE 1002 may apply a beam mapping configuration or a frequency hopping configuration. The UE may apply the beam mapping configuration or the frequency hopping configuration based on the joint channel estimation configuration and at least one of a received frequency hopping configuration or a received beam mapping configuration. For example, the UE may apply the beam mapping configuration in instances where the UE received the joint channel estimation configuration and the beam mapping configuration. In another example, the UE may apply the frequency hopping configuration in instances where the UE received the joint channel estimation configuration and the frequency hopping configuration.

At 1012, the UE 1002 may communicate based on the received frequency hopping configuration or the received beam mapping configuration. The UE may communicate, with the base station 1004, based on the received frequency hopping configuration or the received beam mapping configuration. The base station 1004 may receive uplink transmission based on the at least one of the frequency hopping configuration or the beam mapping configuration. The base station 1004 may receive the uplink transmission from the UE 1002. The uplink transmission may be based on the at least one of the frequency hopping configuration or the beam mapping configuration applied by the UE.

At 1014, the UE 1002 may maintain phase continuity. For example, the UE 1002 may maintain phase continuity across one or more TBs and across repetitions of a same one or more TBs scheduled by the DCI. In some aspects, phase continuity may be maintained across transmission occasions of all TBs scheduled by the DCI that are associated with a same frequency hop. In some aspects, cyclic or interlaced TB mapping may be applied when joint channel estimation across different TBs is configured and frequency hopping is enabled. In some aspects, the frequency hopping configuration may comprise a first half of transmission occasions allocated to a first frequency hop and a second half of transmission occasions allocated to a second frequency hop when joint channel estimation across different TBs is configured and cyclic/interlaced TB mapping is configured. In some aspects, the frequency hopping configuration may comprise a first half of transmission occasions allocated to a first frequency hop and a second half of transmission occasions allocated to a second frequency hop. In some aspects, phase continuity may be maintained across transmission occasions of all TBs scheduled by the DCI that are associated with a same beam. In some aspects, cyclic/interlaced TB mapping is applied when joint channel estimation across different TBs is configured and multiple transmission reception points (TRPs) is enabled. In some aspects, the beam mapping configuration may comprise a first half of transmission occasions allocated to a first beam and a second half of transmission occasions allocated to a second beam when joint channel estimation across different TBs is configured and cyclic/interlaced TB mapping is configured. In some aspects, the beam mapping configuration may comprise a first half of transmission occasions allocated to a first beam and a second half of transmission occasions allocated to a second beam. In some aspects, phase continuity may be maintained across X transmission occasions of all TBs scheduled by the DCI. A value for X may be configured via RRC signaling. The frequency hopping configuration may be based on the value of X. The beam mapping configuration may be based on the value of X. The X transmission occasions may be consecutive or non-consecutive.

As another example, the UE 1002 may maintain phase continuity across repetitions of a same TB scheduled by the DCI. In some aspects, phase continuity may be maintained across transmission occasions of a particular TB scheduled by the DCI that belong to a same frequency hop. In some aspects, sequential TB mapping may be applied when joint channel estimation across the same TBs is configured and frequency hopping is enabled. In some aspects, the frequency hopping configuration may comprise a first half of transmission occasions of a particular TB allocated to a first frequency hop and a second half of transmission occasions of a particular TB allocated to a second frequency hop when joint channel estimation across the same TB is configured and sequential TB mapping is configured. In some aspects, the frequency hopping configuration may comprise a first half of transmission occasions of a particular TB allocated to a first frequency hop and a second half of transmission occasions of a particular TB allocated to a second frequency hop. In some aspects, phase continuity may be maintained across transmission occasions of a particular TB scheduled by the DCI that are associated with a same beam. In some aspects, sequential TB mapping may be applied when joint channel estimation across the same TB is configured and multi-TRP is enabled. In some aspects, the beam mapping configuration may comprise a first half of transmission occasions of a particular TB allocated to a first beam and a second half of transmission occasions of a particular TB allocated to a second beam when joint channel estimation across the same TB is configured and sequential TB mapping is configured. In some aspects, the beam mapping configuration may comprise a first half of transmission occasions of a particular TB allocated to a first beam and a second half of transmission occasions of a particular TB allocated to a second beam. In some aspects, phase continuity may be maintained across X transmission occasions of a particular TB scheduled by the DCI. A value for X may be configured via RRC signaling. The frequency hopping configuration may be based on the value of X. The beam mapping configuration may be based on the value of X. The X transmission occasions may be consecutive or non-consecutive.

At 1016, the base station 1004 may perform a joint channel estimation procedure. The base station 1004 may perform a joint channel estimation procedure on the uplink transmission received from the UE 1002.

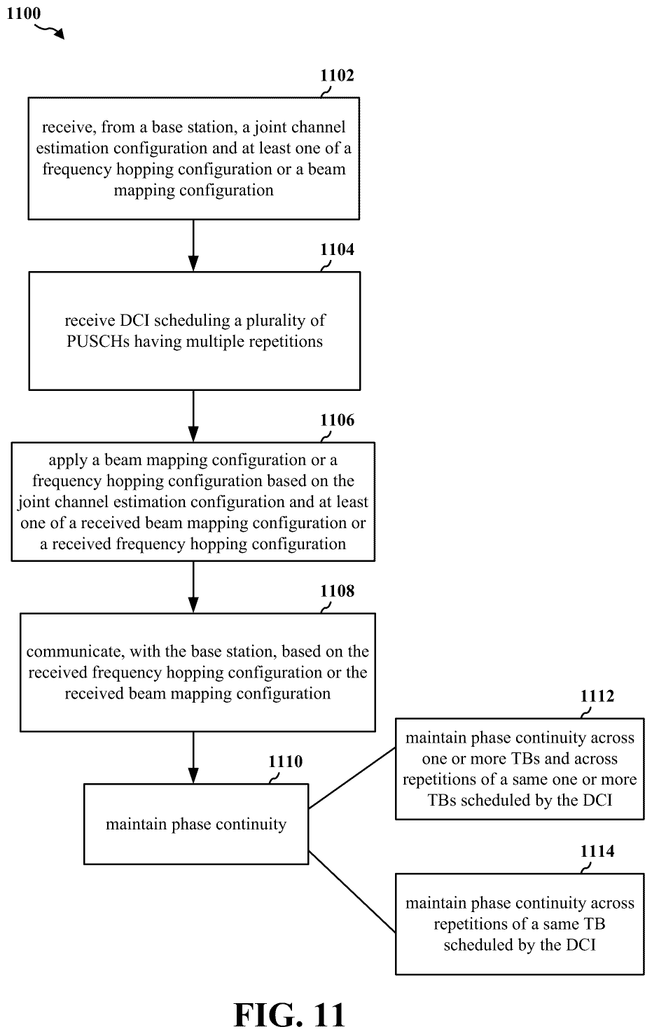

FIG. 11 is a flowchart 1100 of a method of wireless communication. The method may be performed by a UE or a component of a UE (e.g., the UE 104; the apparatus 1202; the cellular baseband processor 1204, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to apply a beam mapping configuration or a frequency hopping configuration when joint channel estimation is configured.

At 1102, the UE may receive a joint channel estimation configuration. For example, 1102 may be performed by configuration component 1240 of apparatus 1202. The UE may receive the joint channel estimation configuration and at least one of a frequency hopping configuration or a beam mapping configuration. The UE may receive the joint channel estimation configuration and at least one of the frequency hopping configuration or the beam mapping configuration from a base station. The frequency hopping configuration or the beam mapping configuration may be received in a signal separate from the joint channel estimation configuration, or in the same signal together with the joint channel estimation configuration.

At 1104, the UE may receive DCI scheduling a plurality of PUSCHs. For example, 1104 may be performed by DCI component 1242 of apparatus 1202. The UE may receive the DCI from the base station. The DCI may schedule the plurality of PUSCHs having multiple repetitions.

At 1106, the UE may apply a beam mapping configuration or a frequency hopping configuration. For example, 1106 may be performed by apply component 1244 of apparatus 1202. The UE may apply the beam mapping configuration or the frequency hopping configuration based on the joint channel estimation configuration and at least one of a received beam mapping configuration or a received frequency hopping configuration. For example, the UE may apply the beam mapping configuration in instances where the UE received the joint channel estimation configuration and the beam mapping configuration. In another example, the UE may apply the frequency hopping configuration in instances where the UE received the joint channel estimation configuration and the frequency hopping configuration.

At 1108, the UE may communicate based on the received frequency hopping configuration or the received beam mapping configuration. For example, 1108 may be performed by communication component 1246 of apparatus 1202. The UE may communicate, with the base station, based on the received frequency hopping configuration or the received beam mapping configuration.

At 1110, the UE may maintain phase continuity. For example, at 1112, the UE may maintain phase continuity across one or more TBs and across repetitions of a same one or more TBs scheduled by the DCI. For example, 1112 may be performed by phase continuity component 1248 of apparatus 1202. In some aspects, phase continuity may be maintained across transmission occasions of all TBs scheduled by the DCI that are associated with a same frequency hop. In some aspects, cyclic or interlaced TB mapping may be applied when joint channel estimation across different TBs is configured and frequency hopping is enabled. In some aspects, the frequency hopping configuration may comprise a first half of transmission occasions allocated to a first frequency hop and a second half of transmission occasions allocated to a second frequency hop when joint channel estimation across different TBs is configured and cyclic/interlaced TB mapping is configured. In some aspects, the frequency hopping configuration may comprise a first half of transmission occasions allocated to a first frequency hop and a second half of transmission occasions allocated to a second frequency hop. In some aspects, phase continuity may be maintained across transmission occasions of all TBs scheduled by the DCI that are associated with a same beam. In some aspects, cyclic/interlaced TB mapping is applied when joint channel estimation across different TBs is configured and multi transmission reception points (TRPs) is enabled. In some aspects, the beam mapping configuration may comprise a first half of transmission occasions allocated to a first beam and a second half of transmission occasions allocated to a second beam when joint channel estimation across different TBs is configured and cyclic/interlaced TB mapping is configured. In some aspects, the beam mapping configuration may comprise a first half of transmission occasions allocated to a first beam and a second half of transmission occasions allocated to a second beam. In some aspects, phase continuity may be maintained across X transmission occasions of all TBs scheduled by the DCI. A value for X may be configured via RRC signaling. The frequency hopping configuration may be based on the value of X. The beam mapping configuration may be based on the value of X. The X transmission occasions may be consecutive or non-consecutive.

As another example, at 1114, the UE may maintain phase continuity across repetitions of a same TB scheduled by the DCI. For example, 1114 may be performed by phase continuity component 1248 of apparatus 1202. In some aspects, phase continuity may be maintained across transmission occasions of a particular TB scheduled by the DCI that belong to a same frequency hop. In some aspects, sequential TB mapping may be applied when joint channel estimation across the same TBs is configured and frequency hopping is enabled. In some aspects, the frequency hopping configuration may comprise a first half of transmission occasions of a particular TB allocated to a first frequency hop and a second half of transmission occasions of a particular TB allocated to a second frequency hop when joint channel estimation across the same TB is configured and sequential TB mapping is configured. In some aspects, the frequency hopping configuration may comprise a first half of transmission occasions of a particular TB allocated to a first frequency hop and a second half of transmission occasions of a particular TB allocated to a second frequency hop. In some aspects, phase continuity may be maintained across transmission occasions of a particular TB scheduled by the DCI that are associated with a same beam. In some aspects, sequential TB mapping may be applied when joint channel estimation across the same TB is configured and multi-TRP is enabled. In some aspects, the beam mapping configuration may comprise a first half of transmission occasions of a particular TB allocated to a first beam and a second half of transmission occasions of a particular TB allocated to a second beam when joint channel estimation across the same TB is configured and sequential TB mapping is configured. In some aspects, the beam mapping configuration may comprise a first half of transmission occasions of a particular TB allocated to a first beam and a second half of transmission occasions of a particular TB allocated to a second beam. In some aspects, phase continuity may be maintained across X transmission occasions of a particular TB scheduled by the DCI. A value for X may be configured via RRC signaling. The frequency hopping configuration may be based on the value of X. The beam mapping configuration may be based on the value of X. The X transmission occasions may be consecutive or non-consecutive.

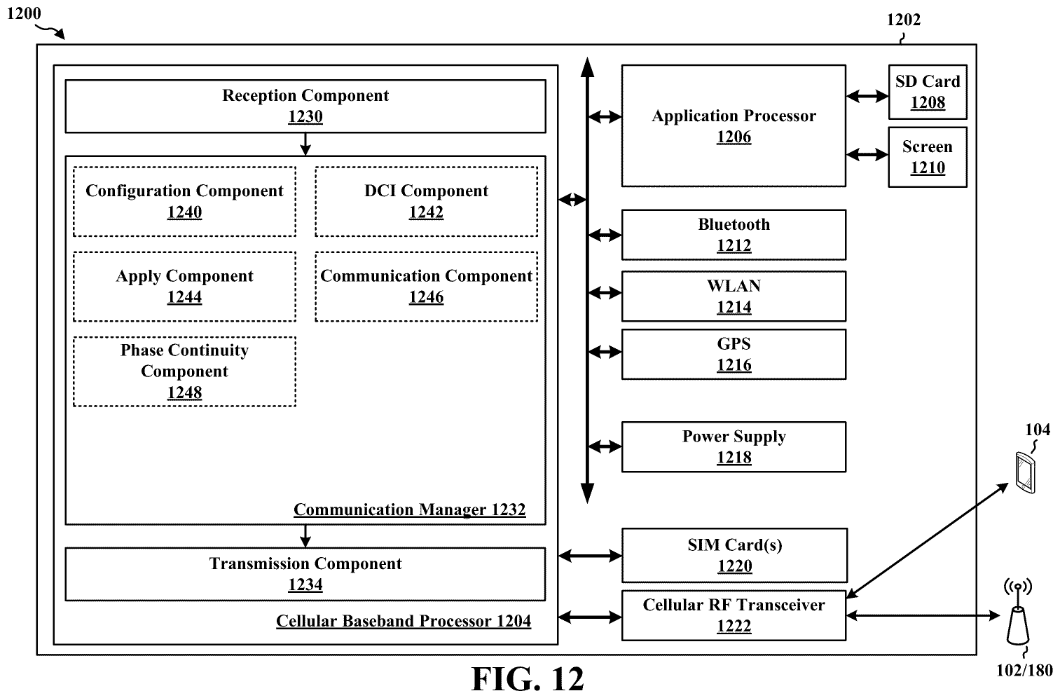

FIG. 12 is a diagram 1200 illustrating an example of a hardware implementation for an apparatus 1202. The apparatus 1202 may be a UE, a component of a UE, or may implement UE functionality. In some aspects, the apparatus 1202 may include a cellular baseband processor 1204 (also referred to as a modem) coupled to a cellular RF transceiver 1222. In some aspects, the apparatus 1202 may further include one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, or a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the additional modules of the apparatus 1202.

The communication manager 1232 includes a configuration component 1240 that is configured to receive a joint channel estimation configuration, e.g., as described in connection with 1102 of FIG. 11. The communication manager 1232 further includes a DCI component 1242 that is configured to receive DCI scheduling a plurality of PUSCHs, e.g., as described in connection with 1104 of FIG. 11. The communication manager 1232 further includes an apply component 1244 that is configured to apply a beam mapping configuration or a frequency hopping configuration, e.g., as described in connection with 1106 of FIG. 11. The communication manager 1232 further includes a communication component 1246 that is configured to communicate based on the received frequency hopping configuration or the received beam mapping configuration, e.g., as described in connection with 1108 of FIG. 11. The communication manager 1232 further includes a phase continuity component 1248 that is configured to maintain phase continuity across one or more TBs and across repetitions of a same one or more TBs scheduled by the DCI, e.g., as described in connection with 1112 of FIG. 11. The phase continuity component 1248 may be further configured to maintain phase continuity across repetitions of a same TB scheduled by the DCI, e.g., as described in connection with 1114 of FIG. 11.

The apparatus may include additional components that perform each of the blocks of the algorithm in the flowchart of FIG. 11. As such, each block in the flowchart of FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the cellular baseband processor 1204, includes means for receiving, from a base station, a joint channel estimation configuration and at least one of a frequency hopping configuration or a beam mapping configuration. The apparatus includes means for receiving DCI scheduling a plurality of PUSCHs having multiple repetitions. The apparatus includes means for applying a beam mapping configuration or a frequency hopping configuration based on the joint channel estimation configuration and at least one of a received beam mapping configuration or a received frequency hopping configuration. The apparatus includes means for communicating, with the base station, based on the received frequency hopping configuration or the received beam mapping configuration. The apparatus includes means for maintaining phase continuity across one or more TBs scheduled by the DCI. The apparatus further includes means for maintaining phase continuity across repetitions of a same one or more TBs scheduled by the DCI. The apparatus further includes means for maintaining phase continuity across repetitions of a same TB scheduled by the DCI.

The means may be one or more of the components of the apparatus 1202 configured to perform the functions recited by the means. As described supra, the apparatus 1202 may include the TX Processor 368, the RX Processor 356, and the controller/processor 359. As such, in one configuration, the means may be the TX Processor 368, the RX Processor 356, and the controller/processor 359 configured to perform the functions recited by the means.

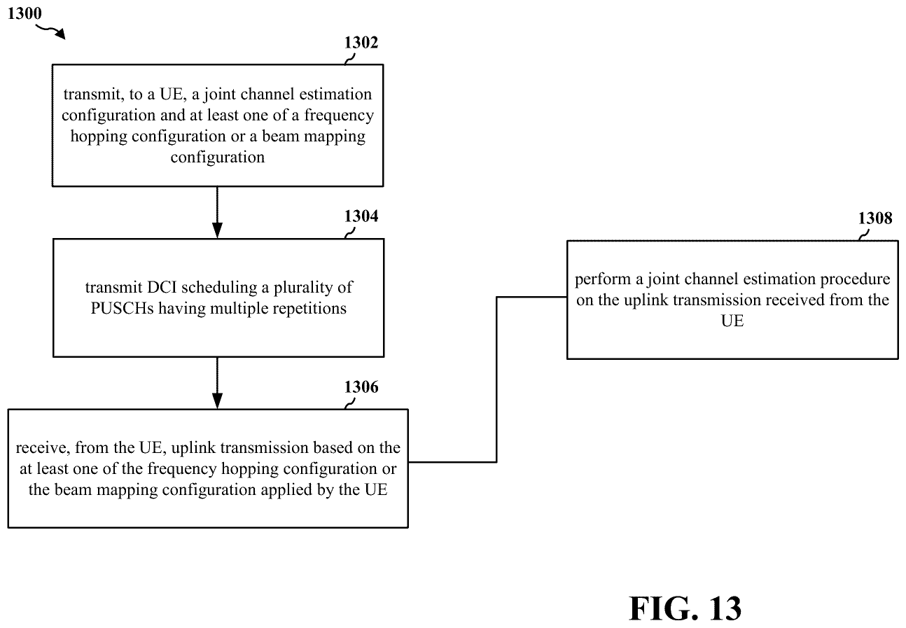

FIG. 13 is a flowchart 1300 of a method of wireless communication. The method may be performed by a base station or a component of a base station (e.g., the base station 102/180; the apparatus 1402; the baseband unit 1404, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to configure a UE to apply a beam mapping configuration or a frequency hopping configuration when joint channel estimation is configured.

At 1302, the base station may transmit a joint channel estimation configuration. For example, 1302 may be performed by configuration component 1440 of apparatus 1402. The base station may transmit the joint channel estimation configuration and at least one of a frequency hopping configuration or a beam mapping configuration. The base station may transmit the joint channel estimation configuration and at least one of the frequency hopping configuration or the beam mapping configuration to a UE. The frequency hopping configuration or the beam mapping configuration may be transmitted to the UE in a signal separate from the joint channel estimation configuration, or may be transmitted to the UE in the same signal together with the joint channel estimation configuration.

At 1304, the base station may transmit DCI scheduling a plurality of PUSCHs. For example, 1304 may be performed by DCI component 1442 of apparatus 1402. The base station may transmit DCI scheduling a plurality of PUSCHs having multiple repetitions. In some aspects, the joint channel estimation procedure may be performed over each of one or more transmission occasions of the PUSCHs. In some aspects, the one or more transmission occasions are consecutive or non-consecutive, wherein PT-RS is used to estimate a phase offset.

At 1306, the base station may receive uplink transmission based on the at least one of the frequency hopping configuration or the beam mapping configuration. For example, 1306 may be performed by uplink component 1444 of apparatus 1402. The base station may receive the uplink transmission from the UE. The uplink transmission may be based on the at least one of the frequency hopping configuration or the beam mapping configuration applied by the UE. In some aspects, the UE may apply the beam mapping configuration in instances where the UE received the joint channel estimation configuration and the beam mapping configuration. In some aspects, the UE may apply the frequency hopping configuration in instances where the UE received the joint channel estimation configuration and the frequency hopping configuration.

At 1308, the base station may perform a joint channel estimation procedure. For example, 1308 may be performed by estimation component 1446 of apparatus 1402. The base station may perform a joint channel estimation procedure on the uplink transmission received from the UE.

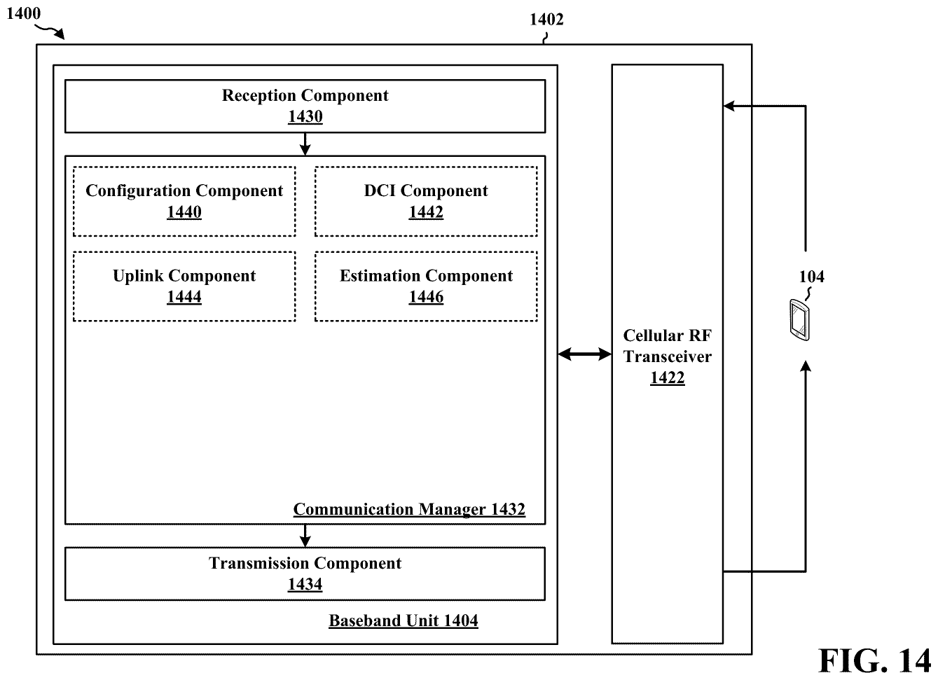

FIG. 14 is a diagram 1400 illustrating an example of a hardware implementation for an apparatus 1402. The apparatus 1402 may be a base station, a component of a base station, or may implement base station functionality. In some aspects, the apparatus 1402 may include a baseband unit 1404. The baseband unit 1404 may communicate through a cellular RF transceiver 1422 with the UE 104. The baseband unit 1404 may include a computer-readable medium/memory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the base station 310 and may include the memory 376 and/or at least one of the TX processor 316, the RX processor 370, and the controller/processor 375.

The communication manager 1432 includes a configuration component 1440 that may transmit a joint channel estimation configuration, e.g., as described in connection with 1302 of FIG. 13. The communication manager 1432 further includes a DCI component 1442 that may transmit DCI scheduling a plurality of PUSCHs, e.g., as described in connection with 1304 of FIG. 13. The communication manager 1432 further includes an uplink component 1444 that may receive uplink transmission based on the at least one of the frequency hopping configuration or the beam mapping configuration, e.g., as described in connection with 1306 of FIG. 13. The communication manager 1432 further includes an estimation component 1446 that may perform a joint channel estimation procedure, e.g., as described in connection with 1308 of FIG. 13.

The apparatus may include additional components that perform each of the blocks of the algorithm in the flowchart of FIG. 13. As such, each block in the flowchart of FIG. 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the baseband unit 1404, includes means for transmitting, to a UE, a joint channel estimation configuration and at least one of a frequency hopping configuration or a beam mapping configuration. The apparatus includes means for transmitting DCI scheduling a plurality of PUSCHs having multiple repetitions. The apparatus includes means for receiving, from the UE, uplink transmission based on the at least one of the frequency hopping configuration or the beam mapping configuration. The apparatus includes means for performing a joint channel estimation procedure on the uplink transmission received from the UE. The means may be one or more of the components of the apparatus 1402 configured to perform the functions recited by the means. As described supra, the apparatus 1402 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and a transceiver and configured to receive, from a base station, a joint channel estimation configuration and at least one of a frequency hopping configuration or a beam mapping configuration; receive DCI scheduling a plurality of PUSCHs having multiple repetitions; apply a frequency hopping configuration or a beam mapping configuration based on the joint channel estimation configuration and at least one of a received frequency hopping configuration or a received beam mapping configuration; communicate, with the base station, based on the received frequency hopping configuration or the received beam mapping configuration; and maintain phase continuity across one or more TBs scheduled by the DCI.

Aspect 2 is the apparatus of aspect 1, further includes that the at least one processor is further configured to maintain phase continuity across repetitions of a same one or more TBs scheduled by the DCI.

Aspect 3 is the apparatus of any of aspects 1 and 2, further includes that phase continuity is maintained across transmission occasions of all TBs scheduled by the DCI that are associated with a same frequency hop.

Aspect 4 is the apparatus of any of aspects 1-3, further includes that cyclic/interlaced TB mapping is applied when joint channel estimation across different TBs is configured and frequency hopping is enabled.

Aspect 5 is the apparatus of any of aspects 1-4, further includes that the frequency hopping configuration comprises a first half of transmission occasions allocated to a first frequency hop and a second half of transmission occasions allocated to a second frequency hop when joint channel estimation across different TBs is configured and cyclic/interlaced TB mapping is configured.

Aspect 6 is the apparatus of any of aspects 1-5, further includes that the frequency hopping configuration comprises a first half of transmission occasions allocated to a first frequency hop and a second half of transmission occasions allocated to a second frequency hop.

Aspect 7 is the apparatus of any of aspects 1-6, further includes that phase continuity is maintained across transmission occasions of all TBs scheduled by the DCI that are associated with a same beam.

Aspect 8 is the apparatus of any of aspects 1-7, further includes that cyclic/interlaced TB mapping is applied when joint channel estimation across different TBs is configured and multi-TRPs is enabled.

Aspect 9 is the apparatus of any of aspects 1-8, further includes that the beam mapping configuration comprises a first half of transmission occasions allocated to a first beam and a second half of transmission occasions allocated to a second beam when joint channel estimation across different TBs is configured and cyclic/interlaced TB mapping is configured.

Aspect 10 is the apparatus of any of aspects 1-9, further includes that the beam mapping configuration comprises a first half of transmission occasions allocated to a first beam and a second half of transmission occasions allocated to a second beam.

Aspect 11 is the apparatus of any of aspects 1-10, further includes that phase continuity is maintained across X transmission occasions of all TBs scheduled by the DCI, wherein a value for X is configured via RRC signaling.

Aspect 12 is the apparatus of any of aspects 1-11, further includes that the frequency hopping configuration is based on the value of X, wherein the beam mapping configuration is based on the value of X, wherein the X transmission occasions are consecutive or non-consecutive.

Aspect 13 is the apparatus of any of aspects 1-12, further includes that the at least one processor is further configured to maintain phase continuity across repetitions of a same TB scheduled by the DCI.

Aspect 14 is the apparatus of any of aspects 1-13, further includes that phase continuity is maintained across transmission occasions of a particular TB scheduled by the DCI that belong to a same frequency hop.

Aspect 15 is the apparatus of any of aspects 1-14, further includes that sequential TB mapping is applied when joint channel estimation across the same TBs is configured and frequency hopping is enabled.

Aspect 16 is the apparatus of any of aspects 1-15, further includes that the frequency hopping configuration comprises a first half of transmission occasions of a particular TB allocated to a first frequency hop and a second half of transmission occasions of a particular TB allocated to a second frequency hop when joint channel estimation across the same TB is configured and sequential TB mapping is configured.

Aspect 17 is the apparatus of any of aspects 1-16, further includes that the frequency hopping configuration comprises a first half of transmission occasions of a particular TB allocated to a first frequency hop and a second half of transmission occasions of a particular TB allocated to a second frequency hop.

Aspect 18 is the apparatus of any of aspects 1-17, further includes that phase continuity is maintained across transmission occasions of a particular TB scheduled by the DCI that are associated with a same beam.

Aspect 19 is the apparatus of any of aspects 1-18, further includes that sequential TB mapping is applied when joint channel estimation across the same TB is configured and multi-TRP is enabled.

Aspect 20 is the apparatus of any of aspects 1-19, further includes that the beam mapping configuration comprises a first half of transmission occasions of a particular TB allocated to a first beam and a second half of transmission occasions of a particular TB allocated to a second beam when joint channel estimation across the same TB is configured and sequential TB mapping is configured.

Aspect 21 is the apparatus of any of aspects 1-20, further includes that the beam mapping configuration comprises a first half of transmission occasions of a particular TB allocated to a first beam and a second half of transmission occasions of a particular TB allocated to a second beam.

Aspect 22 is the apparatus of any of aspects 1-21, further includes that phase continuity is maintained across X transmission occasions of a particular TB scheduled by the DCI, wherein a value for X is configured via RRC signaling.

Aspect 23 is the apparatus of any of aspects 1-22, further includes that the frequency hopping configuration is based on the value of X, wherein the beam mapping configuration is based on the value of X, wherein the X transmission occasions are consecutive or non-consecutive.

Aspect 24 is a method of wireless communication for implementing any of aspects 1-23.

Aspect 25 is an apparatus for wireless communication including means for implementing any of aspects 1-23.

Aspect 26 is a computer-readable medium storing computer executable code, where the code when executed by a processor causes the processor to implement any of aspects 1-23.

Aspect 27 is an apparatus for wireless communication at a base station including at least one processor coupled to a memory and a transceiver and configured to transmit, to a UE, a joint channel estimation configuration and at least one of a frequency hopping configuration or a beam mapping configuration; transmit DCI scheduling a plurality of PUSCHs having multiple repetitions; receive, from the UE, uplink transmission based on the at least one of the frequency hopping configuration or the beam mapping configuration; and perform a joint channel estimation procedure on the uplink transmission received from the UE.

Aspect 28 is the apparatus of aspect 27, further includes that the joint channel estimation procedure is performed over each of one or more transmission occasions of the PUSCHs.

Aspect 29 is the apparatus of any of aspects 27 and 28, further includes that the one or more transmission occasions are consecutive or non-consecutive, wherein PT-RS are used to estimate a phase offset.

Aspect 30 is a method of wireless communication for implementing any of aspects 27-290.

Aspect 31 is an apparatus for wireless communication including means for implementing any of aspects 27-29.

Aspect 32 is a computer-readable medium storing computer executable code, where the code when executed by a processor causes the processor to implement any of aspects 27-29.

What is claimed is:

1. An apparatus for wireless communication at a user equipment (UE), comprising:
a memory;
a transceiver; and
at least one processor coupled to the memory and the transceiver, the at least one processor configured to:
receive, from a base station, a joint channel estimation configuration and at least one of a frequency hopping configuration or a beam mapping configuration;
receive downlink control information (DCI) scheduling a plurality of physical uplink shared channels (PUSCHs) having multiple repetitions;
apply a frequency hopping configuration or a beam mapping configuration based on the joint channel estimation configuration and at least one of a received frequency hopping configuration or a received beam mapping configuration;
communicate, with the base station, based on the received frequency hopping configuration or the received beam mapping configuration; and
maintain phase continuity across one or more transport blocks (TBs) scheduled by the DCI.

2. The apparatus of claim 1, wherein the at least one processor is further configured to:
maintain phase continuity across repetitions of a same one or more TBs scheduled by the DCI.

3. The apparatus of claim 2, wherein phase continuity is maintained across transmission occasions of all TBs scheduled by the DCI that are associated with a same frequency hop.

4. The apparatus of claim 2, wherein cyclic/interlaced TB mapping is applied when joint channel estimation across different TBs is configured and frequency hopping is enabled.

5. The apparatus of claim 2, wherein the frequency hopping configuration comprises a first half of transmission occasions allocated to a first frequency hop and a second half of transmission occasions allocated to a second frequency hop when joint channel estimation across different TBs is configured and cyclic/interlaced TB mapping is configured.

6. The apparatus of claim 2, wherein the frequency hopping configuration comprises a first half of transmission occasions allocated to a first frequency hop and a second half of transmission occasions allocated to a second frequency hop.

7. The apparatus of claim 2, wherein phase continuity is maintained across transmission occasions of all TBs scheduled by the DCI that are associated with a same beam.

8. The apparatus of claim 2, wherein cyclic/interlaced TB mapping is applied when joint channel estimation across different TBs is configured and multi transmission reception points (TRPs) is enabled.

9. The apparatus of claim 2, wherein the beam mapping configuration comprises a first half of transmission occasions allocated to a first beam and a second half of transmission occasions allocated to a second beam when joint channel estimation across different TBs is configured and cyclic/interlaced TB mapping is configured.

10. The apparatus of claim 2, wherein the beam mapping configuration comprises a first half of transmission occasions allocated to a first beam and a second half of transmission occasions allocated to a second beam.

11. The apparatus of claim 2, wherein phase continuity is maintained across X transmission occasions of all TBs scheduled by the DCI, wherein a value for X is configured via radio resource control (RRC) signaling.

12. The apparatus of claim 11, wherein the frequency hopping configuration is based on the value of X,
wherein the beam mapping configuration is based on the value of X,
wherein the X transmission occasions are consecutive or non-consecutive.

13. The apparatus of claim 1, wherein the at least one processor is further configured to:
maintain phase continuity across repetitions of a same transport block (TB) scheduled by the DCI.

14. The apparatus of claim 13, wherein phase continuity is maintained across transmission occasions of a particular TB scheduled by the DCI that belong to a same frequency hop.

15. The apparatus of claim 13, wherein sequential TB mapping is applied when joint channel estimation across the same TBs is configured and frequency hopping is enabled.

16. The apparatus of claim 13, wherein the frequency hopping configuration comprises a first half of transmission occasions of a particular TB allocated to a first frequency hop and a second half of transmission occasions of a particular TB allocated to a second frequency hop when joint channel estimation across the same TB is configured and sequential TB mapping is configured.

17. The apparatus of claim 13, wherein the frequency hopping configuration comprises a first half of transmission occasions of a particular TB allocated to a first frequency hop and a second half of transmission occasions of a particular TB allocated to a second frequency hop.

18. The apparatus of claim 13, wherein phase continuity is maintained across transmission occasions of a particular TB scheduled by the DCI that are associated with a same beam.

19. The apparatus of claim 13, wherein sequential TB mapping is applied when joint channel estimation across the same TB is configured and multi-transmission reception point (TRP) is enabled.

20. The apparatus of claim 13, wherein the beam mapping configuration comprises a first half of transmission occasions of a particular TB allocated to a first beam and a second half of transmission occasions of a particular TB allocated to a second beam when joint channel estimation across the same TB is configured and sequential TB mapping is configured.

21. The apparatus of claim 13, wherein the beam mapping configuration comprises a first half of transmission occasions of a particular TB allocated to a first beam and a second half of transmission occasions of a particular TB allocated to a second beam.

22. The apparatus of claim 13, wherein phase continuity is maintained across X transmission occasions of a particular TB scheduled by the DCI, wherein a value for X is configured via radio resource control (RRC) signaling.

23. The apparatus of claim 22, wherein the frequency hopping configuration is based on the value of X,
wherein the beam mapping configuration is based on the value of X,
wherein the X transmission occasions are consecutive or non-consecutive.

24. A method of wireless communication at a user equipment (UE), comprising:
receiving, from a base station, a joint channel estimation configuration and at least one of a frequency hopping configuration or a beam mapping configuration;
receiving downlink control information (DCI) scheduling a plurality of physical uplink shared channels (PUSCHs) having multiple repetitions;
applying a frequency hopping configuration or a beam mapping configuration based on the joint channel estimation configuration and at least one of a received frequency hopping configuration or a received beam mapping configuration; and
communicating, with the base station, based on the received frequency hopping configuration or the received beam mapping configuration; and
maintaining phase continuity across one or more transport blocks (TBs) scheduled by the DCI.

25. The method of claim 24, further comprising:
maintaining phase continuity across repetitions of a same one or more TBs scheduled by the DCI.

26. The method of claim 24, further comprising:
maintaining phase continuity across repetitions of a same transport block (TB) scheduled by the DCI.

27. An apparatus for wireless communication at a base station, comprising:
a memory;
a transceiver; and
at least one processor coupled to the memory and the transceiver, the at least one processor configured to:
transmit, to a user equipment (UE), a joint channel estimation configuration and at least one of a frequency hopping configuration or a beam mapping configuration;
transmit downlink control information (DCI) scheduling a plurality of physical uplink shared channels (PUSCHs) having multiple repetitions;
receive, from the UE, uplink transmission based on the at least one of the frequency hopping configuration or the beam mapping configuration; and
perform a joint channel estimation procedure on the uplink transmission received from the UE.

28. The apparatus of claim 27, wherein the joint channel estimation procedure is performed over each of one or more transmission occasions of the PUSCHs.

29. The apparatus of claim 28, wherein the one or more transmission occasions are consecutive or non-consecutive, wherein phase tracking reference signals (PT-RS) are used to estimate a phase offset.

30. A method of wireless communication at a base station, comprising:
transmitting, to a user equipment (UE), a joint channel estimation configuration and at least one of a frequency hopping configuration or a beam mapping configuration;
transmitting downlink control information (DCI) scheduling a plurality of physical uplink shared channels (PUSCHs) having multiple repetitions;
receiving, from the UE, uplink transmission based on the at least one of the frequency hopping configuration or the beam mapping configuration; and
performing a joint channel estimation procedure on the uplink transmission received from the UE.
